(19) United States
(12) Patent Application Publication
(10) Pub. No.: US 2010/0302170 A1
(43) Pub. Date: Dec. 2, 2010

(54) METHOD FOR OPERATING INPUT MODE OF MOBILE TERMINAL COMPRISING A PLURALITY OF INPUT MEANS

(75) Inventors: Jun Kyu KANG, Seoul (KR); Sang Yoon LEE, Seoul (KR); Ji Won CHOI, Seoul (KR); Dong Seong SEO, Gyeonggi-do (KR)

Correspondence Address: Cha & Reiter, LLC, 17 Arcadian Avenue, Suite 208, Paramus, NJ, 07652, US

(73) Assignee: SAMSUNG ELECTRONICS CO., LTD., Gyeonggi-Do (KR)

(21) Appl. No.: 12/789,506

(22) Filed: May 28, 2010

(30) Foreign Application Priority Data
Jun. 1, 2009 (KR) 10-2009-0047971

(51) Int. Cl. G06F 3/02; G09G 5/00

(52) U.S. Cl. 345/172; 345/156

(57) ABSTRACT

A method of operating an input mode of a mobile terminal having a first input means and a second input means is provided. The method includes: displaying an input screen which is set as a first input mode; determining whether the second input means is in an activated state; and displaying a changed input screen which is set as a second input mode when the second input means is determined to be in an activated state.

### CLAIM OF PRIORITY

This applicant claims, pursuant to 35 USC 119(a), priority to, and the benefit of the earlier filing date of, that patent application entitled “Method for Operating Input Mode of Mobile Terminal Comprising a Plurality of Input Means,” filed in the Korean Patent Office on Jun. 1, 2009 and afforded serial number 10-2009-0047971, the contents of which are incorporated by reference, herein.

### BACKGROUND OF THE INVENTION

1. Field of the Invention

The present invention relates to the field of mobile devices and, more particularly, to a method for converting an input mode and changing a display according to the converted input mode.

2. Description of the Related Art

As mobile terminals are becoming more widely distributed, a mobile terminal has become a personal necessity. Mobile terminals are now providing not only its original voice call service, but also a variety of different data transmission services and many additional services converting the mobile terminal into a multimedia communication device.

The existing mobile terminal generally includes an input means based on a 3*4 keypad, wherein a user can input alphanumeric (e.g., numbers), Korean, English and special characters or the like. However, the 3*4 keypad has a limitation in terms of speed and convenience, and in order to overcome such a limitation, a mobile terminal based on a QWERTY keypad, which reflects a PC keyboard arrangement, has also been used. In addition, recently, a dual keypad mobile terminal, which can use both a 3*4 keypad and a QWERTY keypad, has been launched.

In a currently used dual keypad mobile terminal, when a user desires to use the QWERTY keypad while using the 3*4 keypad, the user needs to convert the input mode. There can be a situation where the 3*4 keypad is more convenient to use and a situation where the QWERTY keypad is more convenient to use. In such a case that needs frequent changing of the input mode, if a user changes the input mode frequently, the key input time will be delayed. For example, in a menu selection screen where a specific function of a mobile terminal is executed using a hot key, when the hot key is set as a number, if the current input mode is QWERTY keypad input mode, user needs to convert the input mode into a 3*4 keypad mode, and then input the hot key. In addition, when writing a text message, a user may use both a 3*4 keypad and a QWERTY keypad, and in such a case, if the input mode needs to be changed, the text message writing time is delayed.

The present invention suggests a method of operating an input mode by which a user can easily convert the input mode and the optimal key input mode is provided in the converted input mode.

### SUMMARY OF THE INVENTION

The present invention provides a method of operating an input mode by which a user can easily convert the input mode and the optimal key input environment is formed in the converted input mode in a mobile terminal having a plurality of input means.

In accordance with an aspect of the present invention, a method of operating an input mode of a mobile terminal having a first input means and a second input means includes: displaying an input screen that is set as a first input mode; determining whether the second input means is in activated state; and displaying a changed input screen which is set as a second input mode when the second input means is determined to be in an activated state.

In accordance with another aspect of the present invention, a method of operating an input mode of a mobile terminal having a first input means and a second input means includes: displaying an input screen that is set as a first input mode; detecting input of one key among at least one key that constitutes the second input means; and displaying a changed input screen that is set as a second input mode and comprises a character corresponding to the inputted key.

In accordance with another aspect of the present invention, a mobile terminal for operating an input mode, the mobile terminal includes: an input unit which comprises a first input means and a second input means, for generating a corresponding input signal; a display unit which displays an input screen that is set as one of a first input mode and a second input mode; and a controller that determines whether the second input means is in an activated state, and, if the second input means is in an activated state, controls the display unit to change the input screen, which is set as the first input mode, to an input screen, which corresponds to the second input mode, and displays the changed input screen.

In accordance with another aspect of the present invention, a mobile terminal for operating an input mode, the mobile terminal includes: an input unit which comprises a first input means and a second input means, and generates an input signal; a display unit which displays an input screen that is set as one of a first input mode and a second input mode; and a controller that controls the display unit to change an input screen that is set as the first input mode, to an input screen that is set as the second input mode, and display a character corresponding to the inputted key on the changed input screen, if an input signal, which indicates that at least one key, which constitutes the second input means, is inputted, when received from the input unit in the first input mode state.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates components of a mobile terminal according to an exemplary embodiment of the present invention;

FIG. 2 is a flowchart illustrating a method of operating an input mode according to a first exemplary embodiment of the present invention;

FIG. 3A illustrates a menu selection screen which is set as 3*4 keypad mode according to a first exemplary embodiment of the present invention;

FIGS. 3B and 3C illustrate a menu selection screen that is set as QWERTY keypad mode according to a first exemplary embodiment of the present invention;

FIG. 4 is a flowchart illustrating a method of operating an input mode according to a second exemplary embodiment of the present invention;

FIG. 5 is a flowchart illustrating a method of operating an input mode according a third exemplary embodiment of the present invention;

FIG. 6A illustrates a menu input screen which is set as a QWERTY keypad 3*4 keypad mode according to second and third exemplary embodiments of the present invention;

FIG. 6B illustrates a text input screen which is set as a 3*4 keypad mode according to second and third exemplary embodiments of the present invention; and

FIG. 7 illustrates a 3*4 keypad format according to second and third exemplary embodiments of the present invention.

### DETAILED DESCRIPTION OF THE INVENTION

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

In the embodiments of the present invention, a mobile terminal is used as an example, but the present invention is not limited to this example, and can be applied to a large-sized display device such as a television, a computer and a notebook computer including a plurality of input means. A mobile terminal according to the exemplary embodiments of the present invention can also be applied to all information communication devices multimedia devices such as a mobile communication terminal, a portable multimedia player (PMP), a personal digital assistant (PDA), a smart phone and an MP3 player, and the applied products of such devices.

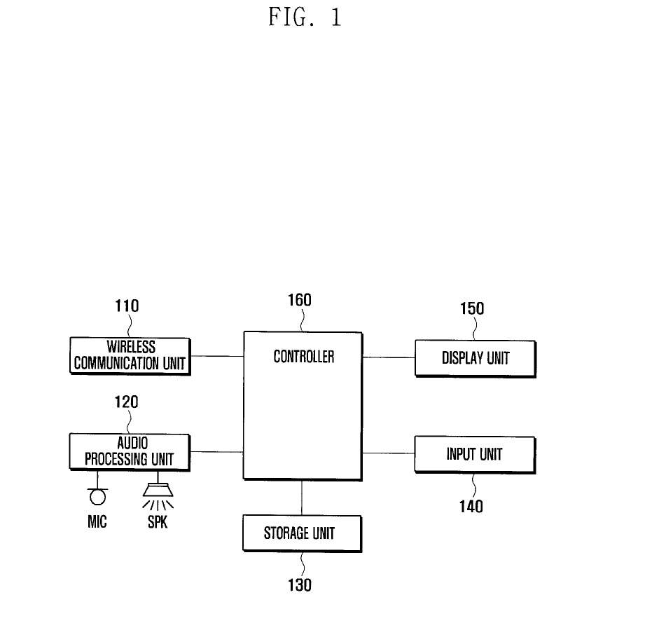

FIG. 1 illustrates components of a mobile terminal according to an exemplary embodiment of the present invention.

A wireless communication unit 110 transmits and receives corresponding data for wireless communication of the mobile terminal. The wireless communication unit 110 may comprise an RF transmitter which up-converts and amplifies the frequency of a signal to be transmitted, and an RF receiver that low-noise amplifies a received signal and down-converts the frequency. The wireless communication unit 110 can receive data through a wireless channel and output the received data to a controller 160, and can transmit data outputted from the controller 160 through the wireless channel.

An audio processing unit 120 may comprise a CODEC, and the CODEC may comprise a data CODEC which processes packet data and the like and an audio CODEC which processes audio signals, like voice. The audio processing unit 120 converts a digital audio signal into an analog audio signal through the audio CODEC that may be played through the speaker, and converts an analog audio signal inputted from a microphone (MIC) into a digital audio signal through the audio CODEC. The audio processing unit 120 according to an exemplary embodiment of the present invention converts a voice signal received from the wireless communication unit 110 into an analog audio signal, and plays the converted signal through a speaker. In addition, the audio processing unit 120 converts an analog audio signal received from a microphone (MIC) into a digital audio signal, and transmits the converted signal to the controller 160. In case at least one key is inputted in a first input means or a second input means, the audio processing unit 120, according to an exemplary embodiment of the present invention, can output an effect sound that is set for each of the first input means and the second input means. In the state where both the first input means and the second means are activated, a user can determine which input means whose key was inputted through an effect sound that is outputted in the audio processing unit 120.

A storage unit 130 plays a role of storing a program and data which are necessary for operating the mobile terminal, and can be classified into a program area and a data area (not shown). The storage unit 130 according to an exemplary embodiment of the present invention matches at least one key, which constitutes a first input means and a second input means, with a function (e.g., an application) that can be executed by a mobile terminal, and stores the key. The key, which is matched with the function of the mobile terminal and is stored, plays a role as a hot key when executing a corresponding function.

An input unit 140 receives a user's key manipulation signal for controlling a mobile terminal, and transmits the inputted signal to the controller 160. The input unit 140 may comprise a key pad including number keys and direction keys (not shown), and the key pad may be in the form of a touch pad, or may be in the form of a key pad which is illustrated on a touch screen in case of a mobile terminal containing on a touch screen (not shown). A hinge device (not shown), which performs an opening/closing operation of a folder or a flip in a folder or flip type mobile terminal of the present invention, and a slide hinge device, which guides a slide operation in a slide type mobile terminal, may be an input unit 140 of the present invention. In addition, other examples of input devices include of an input unit 140 may include a joystick, a dial key, an image sensor and an acceleration sensor or the like (not shown). The input unit 140 according to an exemplary embodiment of the present invention includes a plurality of keypads. Particularly, in one aspect of the invention the input unit 140 comprises at least a 3*4 keypad and a QWERTY keypad.

A display unit 150 may be formed as a liquid crystal display (LCD), and visually provides user with a menu, inputted data, function setting information and various other information of the mobile terminal. For example, the display unit 150 outputs a booting screen, an idle screen, a display screen, a call screen and other application execution screens of a mobile terminal. The display unit 150 according to an exemplary embodiment of the present invention displays an input screen which is set as a first input mode or an input screen which is set as a second input mode depending on the current input mode. Specifically, the display unit 150 displays a menu selection screen that is set by matching at least one key, which constitutes a first input means, in a first input mode, with at least one function that can be executed by the mobile terminal, and displays a menu selection screen that is set by matching at least one key, which constitutes a second input means in a second input means, with at least one function that can be executed by the mobile terminal. In addition, the display unit 150 constitutes a character input screen that is oriented in a same direction as that in which a key constituting a first input means is formed in a first input mode or a second input mode and displays the constituted character input screen.

A controller 160 performs a function that controls general operations of the mobile terminal. The controller 160 according to a first exemplary embodiment of the present invention controls the display unit 150 to display a menu selection screen corresponding to a current mode state. The controller 160 determines whether the current input means or the second input means is in an activated state. According to an exemplary embodiment of the present invention, the controller 160 can control the input means 140 to determine whether a command for activating or deactivating a first input means or a second input means is inputted. In addition, the controller 160 controls the input unit 140 to determine whether the key of the first input means or the second input means is inputted, and execute a function corresponding to the inputted key. The controller 160 according to a second exemplary embodiment of the present invention controls the display unit 150 to display at least one character input screen corresponding to the current mode state. The controller 160 controls the input unit 140 to determine whether the key input of the first input means or the second input is inputted, and controls the display unit 150 to display a character corresponding to the inputted key on the input screen. The controller 160 according to a third exemplary embodiment of the present invention displays a character input screen corresponding to the current mode state in a manner as described with regard to the second exemplary embodiment, and determines whether the first input means or the second input means is in an activated state. The controller 160 according to an exemplary embodiment of the present invention may determine whether a command for activating or deactivating the first input means or the second input means was inputted. The controller 160 determines whether a key of the first input means or the second input means is inputted, and controls the display unit 150 to input and display a character in the character display screen according to the current input mode.

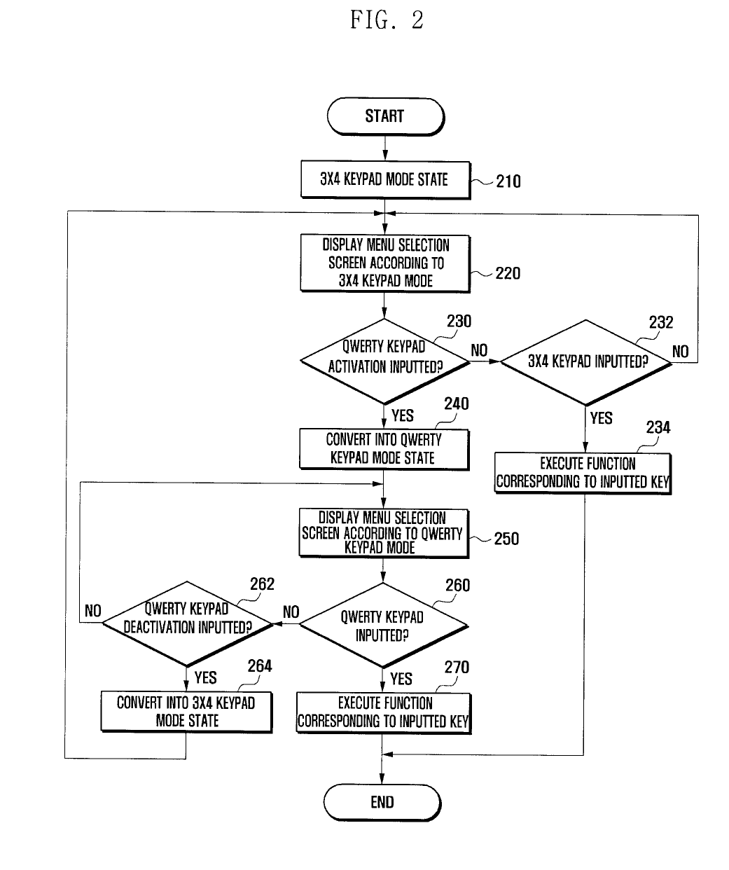

FIG. 2 is a flowchart illustrating a method of operating an input mode according to a first exemplary embodiment of the present invention. The first exemplary embodiment of the present invention relates to a method of operating an input mode when inputting a hot key and executing a corresponding mobile terminal function (application).

The controller 160 sets the input mode of a current mobile terminal as 3*4 keypad mode (210). According to a first exemplary embodiment of the present invention, when the mobile terminal is turned on, the controller may set the default of the input mode of the mobile terminal as 3*4 keypad mode, or can set the default of the input mode as a QWERTY keypad depending on the manufacturer's settings or a user's settings. That is, the default mode may be determined by the device manufacture or by a user.

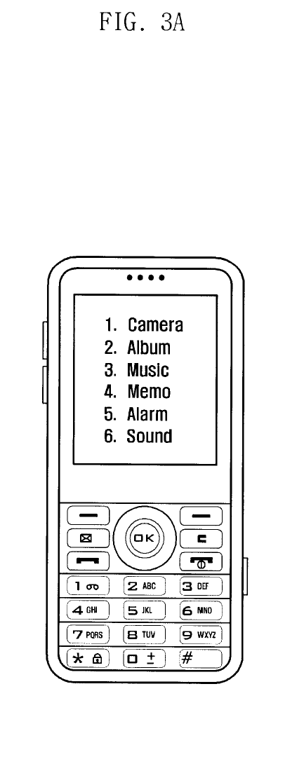

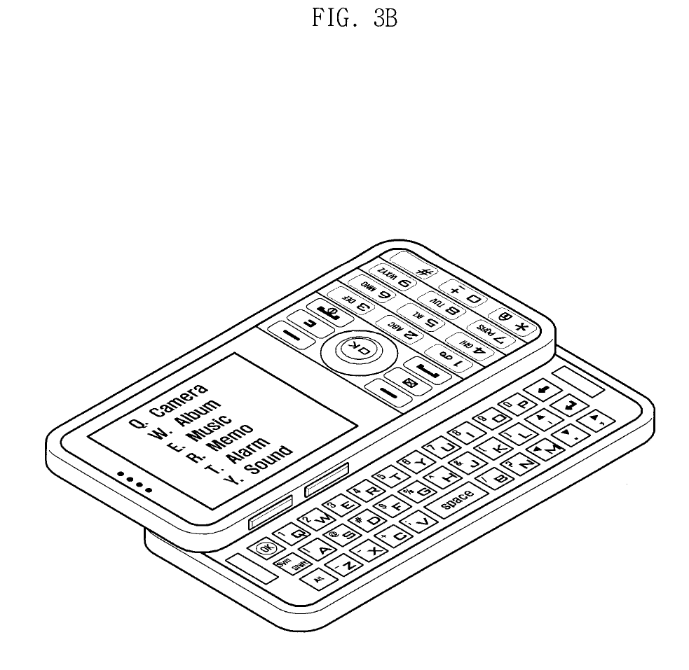

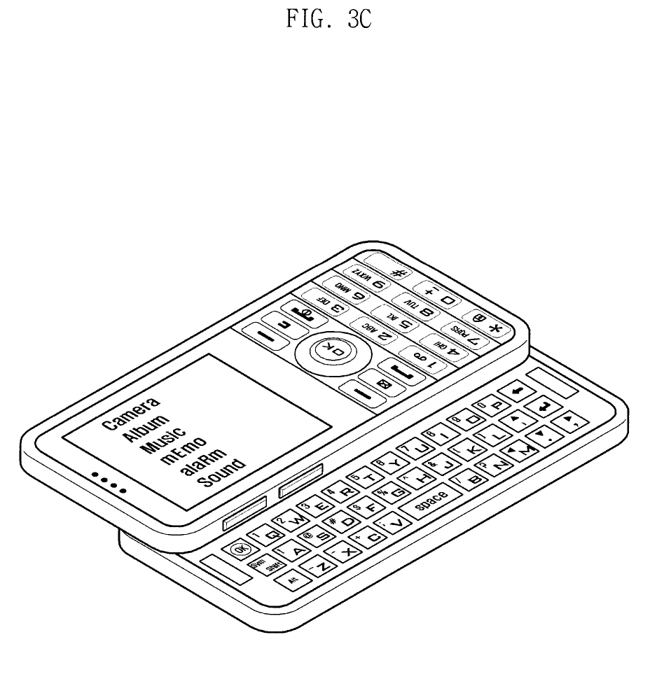

The controller 160 controls the display unit 150 to display a menu selection screen which is set as 3*4 keypad mode (220). The menu selection screen in 3*4 keypad mode matches a key constituting 3*4 keypad with a function of the mobile terminal, and is displayed in the form of a list screen. FIG. 3A illustrates a menu selection screen of 3*4 keypad mode according to a first exemplary embodiment of the present invention. Referring to FIG. 3A, the menus selection screen is set in a form where key “1” corresponds to “camera function”, key “2” corresponds to “album function”, key “3” corresponds to “music function”, key “4” corresponds to “memo function”, key “5” corresponds to “alarm function” and key “6” corresponds to “sound function”.

The controller 160 determines whether a command for activating a QWERTY keypad is inputted (230). In the first exemplary embodiment of the present invention, in case the mobile terminal is a slide type, and a QWERTY keypad is visible when the slide is opened, the controller 160 determines whether the slide is opened through a slider opening/closing device (e.g., a slide hinge device). In case the mobile terminal is a folder type, and the QWERTY keypad is viewable when the folder is opened, the controller 160 determines whether the folder is opened through a folder opening/closing device (e.g., a folder hinge device). In addition, in case a 3*4 keypad and QWERTY keypad are viewable, and a key activating the QWERTY keypad is included in a mobile terminal, the controller 160 determines whether a key activating the QWERTY keypad is inputted. The controller 160 may determine whether the QWERTY keypad is in an activated state by checking the current location state of the QWERTY keypad according to an exemplary embodiment of the present invention.

If a command to activate the QWERTY keypad is inputted, the controller 160 converts the current input mode of the mobile terminal from a 34 keypad mode to a QWERTY keypad mode (240). In the first exemplary embodiment of the present invention, when the input mode is converted into a QWERTY keypad mode, the 3*4 keypad may be converted into a deactivated state, or in the QWERTY keypad mode it is possible for the 34 keypad to continually remain in an activated state.

The controller 160 controls the display unit 150 to display a menu selection screen which is set as a QWRETY keypad mode (250). The menu selection screen of the QWERTY keypad mode is displayed in the form of a list screen which is set by matching a key included in the QWERTY keypad with a mobile terminal function. FIGS. 3B and 3C illustrate an exemplary menu selection screen in a QWERTY keypad mode according to the first exemplary embodiment of the present invention. Referring to FIG. 3B, the menus selection screen is set in a form where key “Q” corresponds to “camera function”, key “W” corresponds to “album function”, key “E” corresponds to “music function”, key “R” corresponds to “memo function”, key “T” corresponds to “alarm function” and key “Y” corresponds to “sound function”. According to an exemplary embodiment of the present invention, the controller 160 controls the display unit 150 to display a menu selection screen in a form where a highlight display effect (e.g., size change, color change, brightness change) is added to an alphabet which represents a function name of the mobile terminal. Referring to FIG. 3C, a menu selection screen is constituted in a form where the size and the color of “C” of the camera function, “A” of the album function, “M” of the music function, “E” of the memo function, “R” of the alarm function and “S” of the sound function are changed.

The controller 160 determines whether a key that constitutes a QWERTY keypad is inputted (260). Particularly, the controller 160 determines whether an alphabet with which a mobile terminal function is matched among a plurality of keys constitutes QWERTY keypad.

In case a user inputs an alphabet with which a mobile terminal function is matched through the QWERTY keypad, the controller 160 receives an input signal from the input unit 140, and executes a portable terminal function corresponding to an inputted alphabet character (270). For example, in case a user inputs “Q” key through the QWERTY keypad, the controller 160 executes “camera function”. According to an exemplary embodiment of the present invention, when a user inputs “Q” through the QWERTY keypad and inputs “OK” key, the controller 160 may execute a corresponding “camera function” Alternatively, when a “Q” is inputted for a longer time, the controller 160 may execute “camera function”.

In case a key that constitutes a QWERTY keypad is not inputted at step 260, the controller 260 determines whether a command to deactivate the QWERTY keypad is inputted (262). The input unit, which receives the input of a command to deactivate the QWERTY keypad, may be in the form of a slide opening/closing device, a folder opening/closing device or a function key in a manner similar to the input unit receiving an input of a command to activate QWERTY keypad. In case the mobile terminal is in the form of a slide or a folder, the controller 160 determines whether a slide or a folder is closed through a slide opening/closing device or a folder opening/closing device, and in case a 3*4 keypad and a QWERTY keypad are viewable, and a QWERTY keypad or a 3*4 keypad is in a form that includes a function key that activates or deactivates the QWERTY keypad or the 3*4 keypad, the controller 160 determines whether a command to deactivate QWERTY keypad is inputted through the function key. According to an exemplary embodiment of the present invention, the controller can determine whether the QWERTY keypad is in deactivated state by checking the current location state of QWERTY keypad.

In case a user inputs a command to deactivate QWERTY keypad, the controller 160 converts the current input mode state of the mobile terminal from a QWERTY keypad mode into a 3*4 keypad mode (264), and displays a menu selection screen that is set as 3*4 keypad mode (220).

In case a command to activate QWERTY keypad is not inputted at step 230, the controller 160 determines whether a key that constitutes a 3*4 keypad is inputted (232). If at least one of the keys that constitute a 3*4 keypad is inputted, the controller recognizes the inputted key, and executes a corresponding function when the recognized key is matched with a mobile terminal function and corresponds to a preset key (234).

According to the first exemplary embodiment of the present invention, the menu selection screen form can be made to be displayed in a form that is appropriate for a keypad that the user currently desires to use only by an operation that activates QWERTY keypad (e.g., an operation that exposes QWERTY keypad), and user can easily input a key and execute a mobile terminal function.

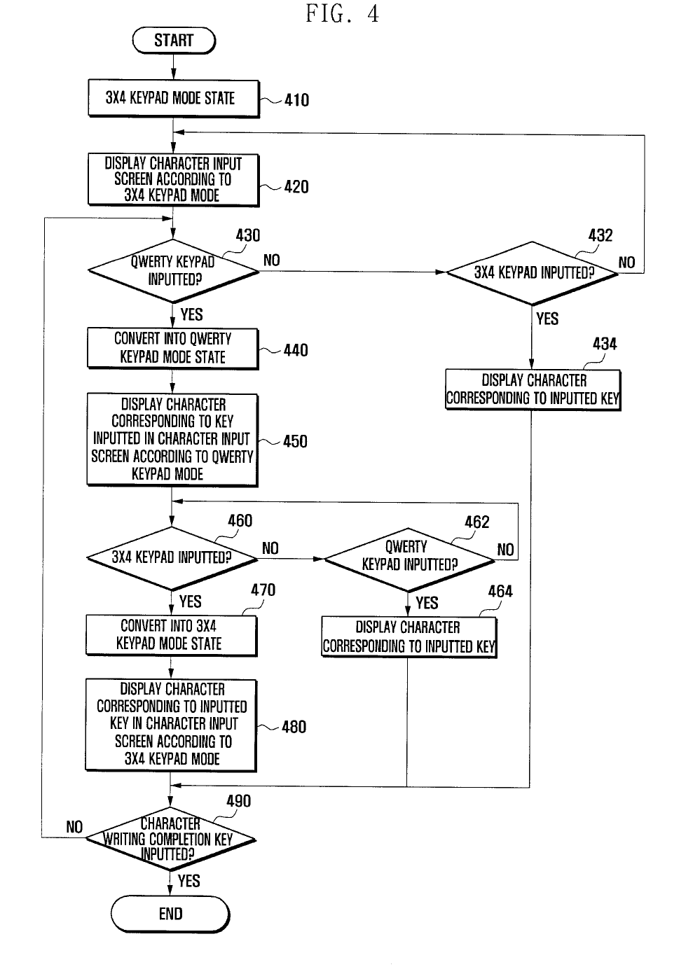

FIG. 4 is a flowchart illustrating a method of operating an input mode according to a second exemplary embodiment of the present invention. The second exemplary embodiment of the present invention relates to a method of operating an input mode in case a character is inputted using both a 3*4 keypad and a QWERTY keypad. Particularly, in the second exemplary embodiment of the present invention, the case of inputting Chinese characters is illustrated. However, the present invention is not limited to this illustrated example, and the present invention can be applied to any language or character set that can be inputted using a 3*4 keypad or a QWERTY keypad.

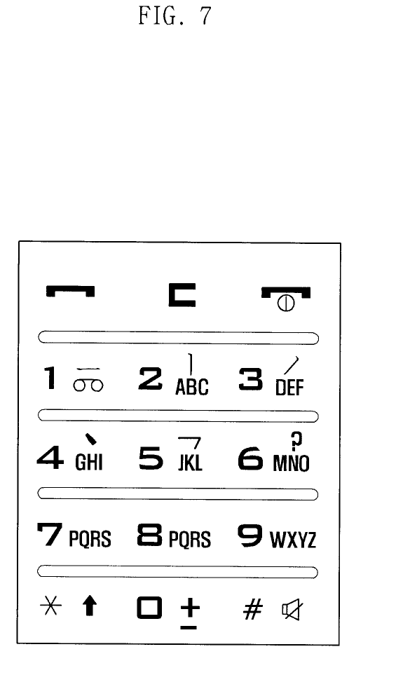

According to the second exemplary embodiment of the present invention, a 3*4 keypad is arranged in a “five letter input” form, and a QWERTY keypad is constituted in a “Pinyin input” form. The “five letter input” form is illustrated in FIG. 7, and it is a format where a Chinese character is constituted by inputting corresponding keys “1” to “5”. The “Pinyin input” format is the same as a general QWERTY keypad, which is composed of alphanumeric characters, and a user inputs Pinyin characters using the alphanumeric characters corresponding to the Chinese characters. In the second exemplary embodiment of the present invention, it is assumed that both the 3*4 keypad and the QWERTY keypad are viewable.

Returning to FIG. 4, the controller 160 sets the current input mode of the mobile terminal in a 3*4 keypad mode (410). That is, in the second exemplary embodiment of the present invention, the controller 160 sets the input mode to default to a 3*4 keypad mode. In the second exemplary embodiment of the present invention, it is featured that the QWERTY keypad is an activated event in the 3*4 keypad mode state. That is, even in a 3*4 keypad mode, if a key that constitutes a QWERTY keypad is inputted, the input unit 140 generates a key input signal, and the controller can receive the key input signal and recognize the key input.

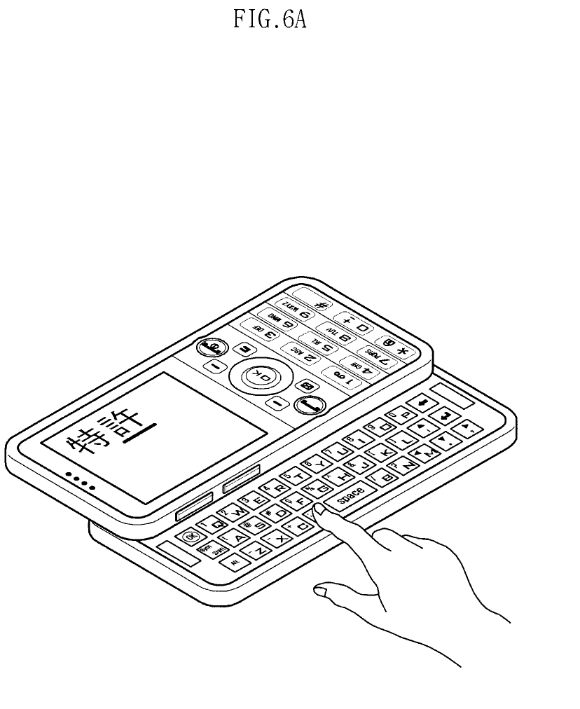

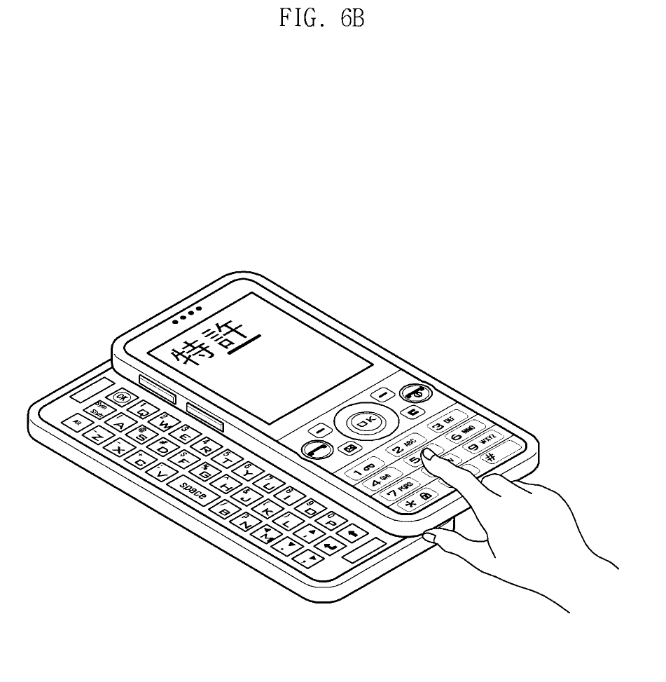

The controller 160 controls the display unit 150 to display a character input screen, which is set as in 3*4 keypad mode (420). The character input screen of 3*4 keypad mode refers to a character input screen where the direction in which the 3*4 keypad is formed in the portable terminal, is the direction corresponding to the characters displayed on the keys. That is, the direction of the input screen is the same as the direction in which the 12 keys constituting 3*4 are formed. Referring to FIG. 6B, the character input screen, where the direction in which 3*4 keypad is formed is that direction that corresponds to the character input screen (“portrait” type) wherein the long side becomes the vertical axis in a rectangle-formed display screen. That is, the character input screen of a 3*4 keypad mode corresponds to a screen where a character is inputted in a direction parallel to the direction in which the key characters “1”, “2” and “3” are formed in the 3*4 keypad. The controller 160 controls the display unit 150 to display a cursor also in the direction in which characters “1”, “2” and “3” are formed.

The controller 160 determines whether a QWERTY keypad is inputted (430). The current input mode is in 3*4 keypad mode, but the QWERTY keypad is in an activated state, so the controller 160 can recognize an input from QWERTY keypad, too.

In case QWERTY keypad is inputted, the controller 160 converts the input mode from a 3*4 keypad mode into a QWERTY keypad mode (440). In the second exemplary embodiment of the present invention, 3*4 keypad remains in an activated state in the QWERTY keypad mode.

The controller 160 controls the display unit 150 to display a character input screen which is set in the QWERTY keypad mode (450), and displays a character corresponding a key inputted at step 430 on the character input screen. The character input screen of QWERTY keypad mode refers to a character input screen where the direction in which QWERTY keypad is formed becomes the correct orientation. Referring to FIG. 6A, the character input screen, where the direction QWERTY keypad is formed becomes the orientation that corresponds to the character input screen (“Landscape” type) where the short side becomes the vertical axis in the display screen. That is, the character input screen corresponds to a screen where a character is inputted in with a same direction in which keys such as “Q”, “W” and “E” or the like are formed in the QWERTY keypad. The controller controls the display unit 150 to display a Chinese character corresponding to a key inputted at step 430 on the character input screen. For example, in case user inputs the character combination “te” through the QWERTY keypad, the controller extracts Chinese characters having the Pinyin, controls the display unit 150 to list and display the extracted Chinese characters, and if “ [symbol] ” is selected among the listed Chinese characters, the controller 160 controls the display unit 150 to display “ [symbol] ”.

The controller 160 determines whether an input signal from the 3*4 keypad is inputted (460). If the controller 160 receives an input signal from the input unit 140 and recognizes that an input from the 3*4 keypad was inputted, the controller 160 converts the current input mode of the mobile terminal from a QWERTY keypad mode into a 3*4 keypad mode (470). Thereafter, the controller 160 controls the display unit 150 to display a character input screen that is set to be in the 3*4 keypad mode (480), and displays a character corresponding to a key inputted at step 460 on the character input screen.

Referring to FIG. 6B, user inputs “ [symbol] ” by inputting the characters “1” to “5” of the 3*4 keypad. In case the user does not know the Pinyin of “ [symbol] ”, it is possible to input the Chinese character using five letters of the 3*4 keypad. Thus, when an input from the 3*4 keypad is inputted, the controller 160 converts the current input mode of the mobile terminal into the 3*4 keypad mode, converts the character input screen into 3*4 keypad mode (“portrait” type), and displays the converted screen. The controller 160 controls the QWERTY keypad to remain in an activated state even in the 3*4 keypad mode.

The controller 160 determines whether a character writing completion key is inputted (490), and if the character writing completion key is inputted, the controller 160 terminates the character writing process.

In case the key of the QWERTY keypad is not inputted at step 430, the controller 160 determines whether a key of the 3*4 keypad is inputted (432). In case a key stroke of the 3*4 keypad is inputted, the controller 160 controls the display unit 150 to display a character corresponding to the inputted key (434). As the current input mode of the mobile terminal is in the 3*4 keypad mode, the controller 160 displays a character corresponding to the inputted key on the character input screen (“portrait” type) of 3*4 keypad mode without changing the input mode.

In case a key from the 3*4 keypad is not inputted at step 460, the controller 160 determines whether a key from the QWERTY keypad is inputted (462). In case a key of QWERTY keypad is inputted, the controller 160 controls the display unit 150 to display a character corresponding to the inputted key (464). As the current input mode of the mobile terminal is in a QWERTY keypad mode, the controller 160 displays a character corresponding to the inputted key on the character input screen (“Landscape” type) of QWERTY keypad mode.

In the second exemplary embodiment of the present invention, the input mode can be converted only by an operation of inputting a key from the QWERTY keypad or from the 3*4 keypad, and the mobile terminal provides a character input screen in a form that is appropriate for the keypad that the user currently desires to use according to the converted input mode.

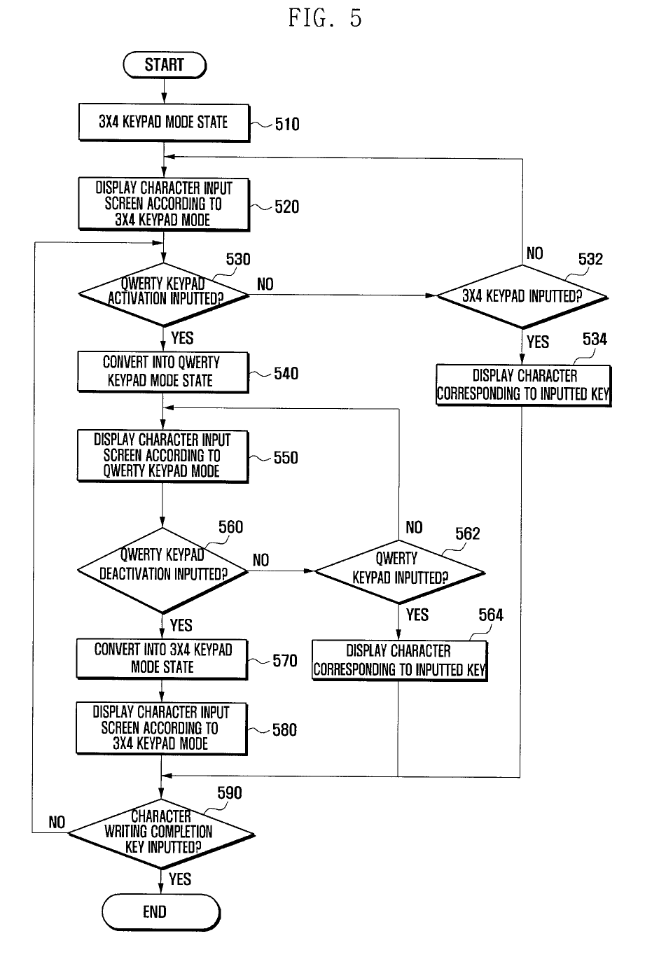

FIG. 5 is a flowchart illustrating a method of operating an input mode according to a third exemplary embodiment of the present invention.

The third exemplary embodiment of the present invention relates to a method of operating an input mode when a character is inputted using both the 3*4 keypad and the QWERTY keypad in a manner similar to that described with regard to the second exemplary embodiment. In the third exemplary embodiment, a case of inputting a Chinese character will be used as an example to describe the principles of the invention. However, it would be understood by those skilled in the art that the principles of the invention are applicable to other languages and/or character sets.

The controller 160 sets the input current input mode of the mobile terminal in the 3*4 keypad mode (510), and controls the display unit 150 to display a character input screen that is set in the 3*4 keypad mode (520). FIG. 6B illustrates a character input screen that is set as 3*4 keypad mode according to a third exemplary embodiment of the present invention, and the character input screen in a form where the long side becomes the vertical axis in a rectangular form display screen (“portrait” type).

The controller 160 determines whether a command to activate the QWERTY keypad is inputted (530). In the third exemplary embodiment of the present invention, in case the mobile terminal is a slide type and QWERTY keypad is constituted to be exposed to the outside when the slide is opened, the controller 160 determines whether the slide is opened through a slide opening/closing device. In case the mobile terminal is folder type and a QWERTY keypad is viewable when the folder is opened, the controller 160 determines whether the folder is opened through the folder opening/closing device. In addition, in case the 3*4 keypad and the QWERTY keypad are viewable and a function key that activates QWERTY keypad is detected, the controller 160 controls the input unit 140 to determine whether the function key is inputted. According to an exemplary embodiment of the present invention, the controller 160 can check the current location state of QWERTY keypad and determine whether the QWERTY keypad is in an activated state.

The controller 160 converts the current input mode of the portable terminal from a 3*4 keypad mode into a QWERTY keypad mode in order to activate the QWERTY keypad (540). According to an exemplary embodiment of the present invention, the controller 160 may convert the 3*4 keypad into a deactivated state when in the QWERTY keypad mode state, or may maintain the activated state of the 3*4 keypad.

The controller 160 controls the display unit 150 to display a character input screen which is set as QWERTY keypad mode (550). The character input screen according to the QWERTY keypad mode refers to a character input screen where the direction in which QWERTY keypad is formed becomes the correct orientation. Referring to FIG. 6A, there is illustrated an orientation of the input screen that corresponds to a character input screen (“Landscape” type) where the short side becomes the vertical axis in a rectangular form display screen.

The controller 160 determines whether a command to deactivate the QWERTY keypad is inputted (560). The input unit, which is inputted the command to deactivate QWERTY keypad, may be in the form of a slide opening/closing device, a folder opening/closing device or a function key. The controller 160 determines whether a command to deactivate QWERTY keypad is inputted by checking whether a slide or a folder is closed or whether a function key for deactivating QWERTY keypad is inputted. According to an exemplary embodiment of the present invention, the controller 160 can determine whether QWERTY keypad is in activated state by checking the current location state of QWERTY keypad.

If a command to deactivate QWERTY keypad is inputted, the controller 160 converts the current input mode state of the mobile terminal from a QWERTY keypad mode into a 3*4 keypad mode (570), and displays a menu selection screen which is set as a 3*4 keypad mode (580). Thereafter, the controller 160 determines whether a character writing completion key is inputted (590), and if the character writing completion key is inputted, the controller 160 terminates the character writing process.

In case a command to activate the QWERTY keypad is not inputted at step 530, the controller 160 determines whether a key of a 3*4 keypad is inputted (532). In case a key stoke of the 3*4 keypad is inputted, the controller 160 displays a character corresponding to the inputted key (534). As the current input mode of the mobile terminal is in 3*4 keypad mode, the controller 160 displays a character on the character input screen (“portrait” type) of 3*4 keypad mode without changing the input mode.

In addition, when a command to deactivate the QWERTY keypad is not inputted at step 560, the controller 160 determines whether the key of QWERTY keypad is inputted (562). In case a key from the QWERTY keypad is inputted, the controller 160 controls the display unit 150 to display a character corresponding to the inputted key (564). As the current input mode of the mobile terminal is QWERTY keypad mode the controller 160 displays a character on the character writing screen (“Landscape” type) of the QWERTY keypad mode without changing the input mode.

In the third exemplary embodiment of the present invention, the input mode can be converted only by an operation of activating the QWERTY keypad (e.g., an operation of exposing the QWERTY keypad), and the mobile terminal provides a character input screen in a form that is appropriate for the keypad that the user currently desires to use according to the converted input mode.

Through the present invention, user can easily convert an input mode of a mobile terminal having a plurality of input means, and can easily input a key by being provided a display screen in a form that is appropriate for the converted input mode.

The above-described methods according to the present invention as being performed in the controller (160) can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the controller, the computer, the processor or the programmable hardware includes memory components, e.g., RAM, ROM, Flash, etc. that may store or receive software or computer code that when accessed and executed by the computer, processor or hardware implement the processing methods described herein. In addition, it would be recognized that when a general purpose computer is loaded with, or accesses, code that may be stored in a memory component, the general purpose computer is transformed into a special purpose computer suitable for at least executing and implementing the processing shown herein. The controller may be implemented in one or more individual and/or multi-core processors.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A method, operable in a controller, for operating an input mode of a mobile terminal having a first input means and a second input means, the method comprising:
displaying an input screen which is set as a first input mode;
determining whether the second input means is in an activated state; and
displaying a changed input screen which is set as a second input mode, when the second input means is in an activated state.

2. The method of claim 1, wherein displaying an input screen which is set as a first input mode comprises:
displaying a menu screen that is set by matching at least one key, which constitutes the first input means, with at least one function, that can be executed by the mobile terminal.

3. The method of claim 1, wherein displaying an input screen which is set as a first input mode comprises:
displaying a character input screen in a same direction as a direction in which a key that constitutes the first input means is formed.

4. The method of claim 1, wherein displaying a changed input screen which is set as a second input mode comprises:
displaying a menu screen that is set by matching at least one key, which constitutes the second input means, with at least one function, that can be executed by the mobile terminal.

5. The method of claim 1, wherein displaying a changed input screen which is set as a second input mode comprises:
displaying a character input screen in a same direction as a direction in which a key that constitutes the second input means is formed.

6. The method of claim 1, wherein displaying a changed input screen which is set as a second input mode comprises:
displaying a menu screen that is set by matching a key combination having a series of arrays among at least one key, which constitutes the second input means, with at least one function that can be executed by the mobile terminal.

7. The method of claim 1, wherein displaying a changed input screen which is set as a second input mode comprises:
displaying a menu screen that is set by matching at least one function, which can be executed by the mobile terminal, with a key corresponding to one of the characters, which constitute a name of each function.

8. A method of operating an input mode of a mobile terminal having a first input means and a second input means, the method comprising:
displaying an input screen that is set as a first input mode;
detecting input of one key among at least one key that constitutes the second input means; and
displaying a changed input screen that is set as a second input mode and comprises a character corresponding to the inputted key.

9. The method of claim 8, wherein displaying an input screen that is set as a first input mode comprises:
displaying a character input screen in a same direction as a direction in which a key, which constitutes the first input means, is formed.

10. The method of claim 8, wherein displaying a changed input screen comprises:
displaying a character corresponding to the inputted key on a character input screen, the character and character input screen being in oriented in a same direction as a direction in which a key, which constitutes the second input means, is formed.

11. A mobile terminal for operating an input mode, the mobile terminal comprising:
an input unit, which comprises a first input means and a second input means, for generating a corresponding input signal;
a display unit which displays an input screen which is set as one of:
a first input mode and a second input mode; and
a controller which determines whether the second input means is in and activated state, and, if the second input means is in activated state, controls the display unit to change the input screen from one mode to another mode.

12. The mobile terminal of claim 11, wherein the controller controls the display unit to display a menu screen which is set by matching at least one key input from the first input means in the first input mode, with at least one function, which can be executed by the mobile terminal, and controls the display unit to display a menu screen that is set by matching at least one key, which constitutes the second input means in the second input mode, with at least one function that can be executed by the mobile terminal.

13. The mobile terminal of claim 11, wherein the controller controls the display unit to display a character input screen in a same direction as a direction in which a key, which constitutes the first input means in the first input mode, is formed and displays a menu input screen oriented in a same direction as a direction in which a key, which constitutes the second input means in the second input mode, is formed.

14. A mobile terminal for operating an input mode, the mobile terminal comprising:
an input unit which comprises a first input means and a second input means, for generating an input signal;
a display unit which displays an input screen which is set as one of a first input mode or a second input mode; and
a controller for controlling:
the display unit to change an input screen from one of said first and second input modes to another of the first and second input modes, and
display a character corresponding to the inputted key on the changed input screen, if the input signal, which indicates that at least one key, which constitutes the second input means, is inputted, is received from the input unit in the first input mode state.

15. The mobile terminal of claim 14, wherein the controller controls the display unit to display a menu screen which is set by matching at least one key, which constitutes the first input means in the first input mode, with at least one function, which can be executed by the mobile terminal, and controls the display unit to display a menu screen which is set by matching at least one key, which constitutes the second input means in the second input mode, with at least one function, which can be executed by the mobile terminal.

16. The mobile terminal of claim 14, wherein the controller controls the display unit to display a character on a character input screen oriented in a same direction as a direction in which a key, which constitutes the first input means in the first input mode, is formed.
